(19) United States
(12) Patent Application Publication
(10) Pub. No.: US 2012/0238163 A1
(43) Pub. Date: Sep. 20, 2012

(54) REINFORCING MESH FOR A REINFORCED MORTAR LAYER OR SPRAYED MORTAR LAYER ON AN UNDERLAYMENT, AND METHOD FOR THE INSTALLATION THEREOF AND REINFORCED MORTAR COATING PRODUCED THEREWITH

(75) Inventor: Josef Scherer, Brunnen (CH)

(73) Assignee: S & P CLEVER REINFORCEMENT COMPANY AG, Seewen (CH)

(21) Appl. No.: 13/393,137

(22) PCT Filed: Aug. 5, 2010
(86) PCT No.: PCT/CH2010/000193

§ 371 Date: Jun. 4, 2012

(30) Foreign Application Priority Data
Aug. 28, 2009 (CH) 1335/09
Jan. 19, 2010 (CH) 64/10
Jan. 21, 2010 (CH) 76/10

(51) Int. Cl. D03D 19/00; D03D 15/00; B23P 17/04; D03D 9/00

(52) U.S. Cl. 442/3; 442/5; 29/527.4

(57) ABSTRACT

A reinforcing mesh for a reinforced mortar or sprayed mortar layer on an underlayment. The reinforcing mesh includes carbon fibers extending only in a marked direction as a special feature and together with inexpensive stabilising fibers made of glass or polyester which extend in one or more other directions, the reinforcing mesh forms a woven fabric, a scrim or a knitted fabric. The reinforcing mesh can be layed by roughening the surface of the underlayment; applying a leveling layer of cementitious mortar to the roughed surface of the underlayment; fastening the reinforcing mesh by processing the reinforcing mesh into the wet, not yet set leveling layer; and applying a cover layer of the identical cementitious mortar to the wet, not yet set, reinforced leveling layer.

The invention relates to a reinforcing mesh for a reinforcing mortar or sprayed mortar layer as well as to a method for the installation of a reinforcing mesh of this type in order to obtain a reinforced mortar coating. Particularly, concrete surfaces, reinforced mortar coatings are largely used amongst others for the maintenance of buildings of different types, especially of cracked concrete surfaces in civil engineering and also by the construction of tunnels.

Mortars for coatings with a grid shaped textile reinforcement are known from the EP-A-0 106 986; the reinforcement of these coatings being voluntarily realised flexible and therefore have a low E-module. It is thereby intended to avoid cracks formation in the external layer due to different thermal extension with regard to the reinforcement mesh. These mortars and their reinforcements are determined particularly for cover coatings of hard foam plates in external insulation systems, but are not really appropriate for bearing coatings or for coatings subjected to stronger mechanical stress, for example, not suitable for over coatings used for cracked bridging in bearing concrete constructions.

A development of a reinforcement of this type and the method for its manufacturing and utilisation can be deduced from EP 0 732 464. The reinforcement web shown in this patent is composed of a woven fabric or a meshwork of fibers strands. The fiber bundels are realised at least partially opened so that a flowable or pasty material is able to penetrate which afterwards hardens. The individual fibers of the strands are thus embedded and integrated into the material. It is indicated that the mesh size is about 12 mm and the tear strength is of at least 20 kN/m with a tensile strength of at most 5%. Carbon fibers are particularly suitable as they are fibers which are able to absorb high tensile forces. But the cost for such carbon fibers are very high and are situated at about CHF 30.-per kg. The cost for fibers of glass or Polyester is only approx. CHF 1.50 per kg and therefore 20 times cheaper.

Hybrid grids are known which present carbon fibers extending in a first direction and Aramid fibers extending in the transversal direction. Moreover, Aramid fibers are even more expensive than the carbon fibers, about twice the price and hybrid grids of this type are contrary to the effort of obtaining a reinforcement as resistant as possible with the lowest possible costs, and thereby to use the carbon fibers only in the direction where tensile forces occur.

The object of the present invention is therefore to indicate a reinforcing mesh for a reinforced mortar layer or sprayed mortar layer on an underlayment an a method for the installation thereof, whereby this reinforcing mesh should be suitable to receive high tensile forces in a determined direction for a strong reinforcement and should offer simultaneously a decisive cost advantage with regard to the known reinforcing webs. Moreover, this reinforcing mesh in a special execution should be particularly resistant to alcaline components of the leveling layer or cover layer, especially against Ca₃Al₂ which is comprised in concrete and therefore made to last indefinitely. Nevertheless, this reinforcing mesh should be easy to apply on the construction site and easy to install. A further object of the present invention is to indicate a produced reinforced mortar layer with a terminal anchoring in a solid underlayment.

This task is solved by a reinforcing mesh for a reinforced mortar or sprayed mortar layer on an underlayment, characterized in that the reinforcing mesh includes carbon fibers extending only in a marked direction, which fibers form together with fibers made of glass or polyester extending in one or more other directions, a woven fabric, a scrim or a knitted fabric having a mesh size of at least 10 mm, whereby the employed carbon fibers have a tensile E-modul of elasticity greater than 200 gigapascals.

The task is further solved by a method for the installation of a reinforcing mesh according to the claims 1 to 8 for producing a reinforced mortar layer or a sprayed mortar layer on an underpayment mostly composed of concrete and according the following method steps:
a) Roughening the surface,
b) Applying a leveling layer aus cementitious mortar to the roughed surface,
c) Fastening the reinforcing mesh by pressing the reinforcing mesh into the wet not yet set leveling layer,
d) Applying a cover layer of the identical cementitious mortar to the wet not yet set reinforced leveling layer.

Finally, the object of the invention is solved in that a reinforced mortar coating is realised according to the method of claim 14 characterised in that the reinforcing mesh of the mortar coating is secured at least on one side of the tensile load of the said mortar coating by means of a corrosion resistant profile which is anchored in the underlayment by means of plugs; the said profile being wrapped at least once by the reinforcing mesh.

The reinforcing mesh is shown in the figures in different embodiments and in the following the construction and installation thereof will be described and explained in order to produce a reinforced mortar oder a sprayed mortar layer. The figures show:

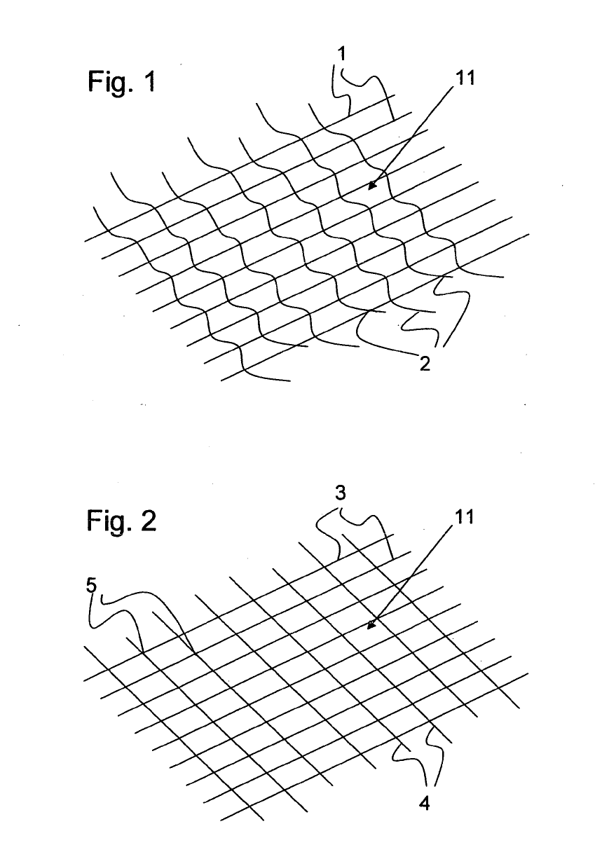

FIG. 1: A reinforcing mesh as a woven fabric including carbon fibers extending only in a marked direction;

FIG. 2: A reinforcing mesh as a scrim including carbon fibers extending only in a marked direction;

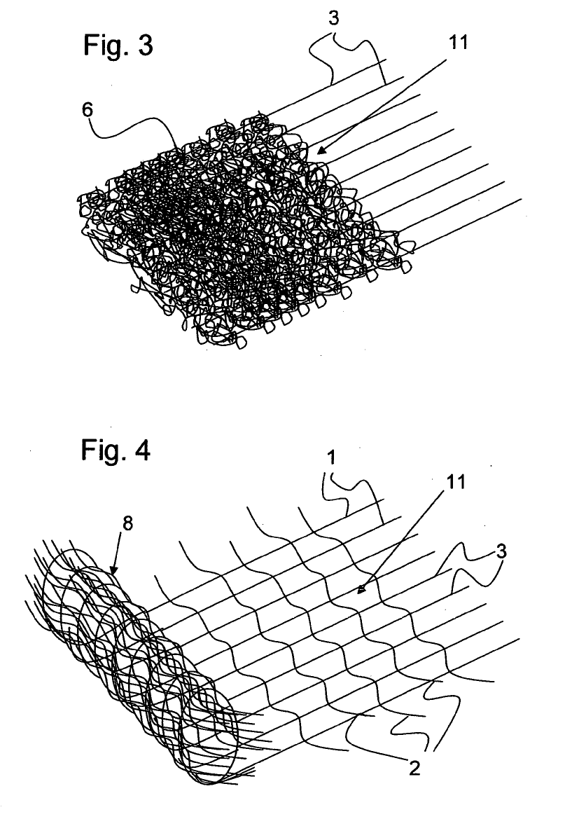

FIG. 3: A reinforcing mesh as knitted fabric including carbon fibers extending only in a marked direction;

FIG. 4: A reinforcing mesh rollep up for the storage and the transport;

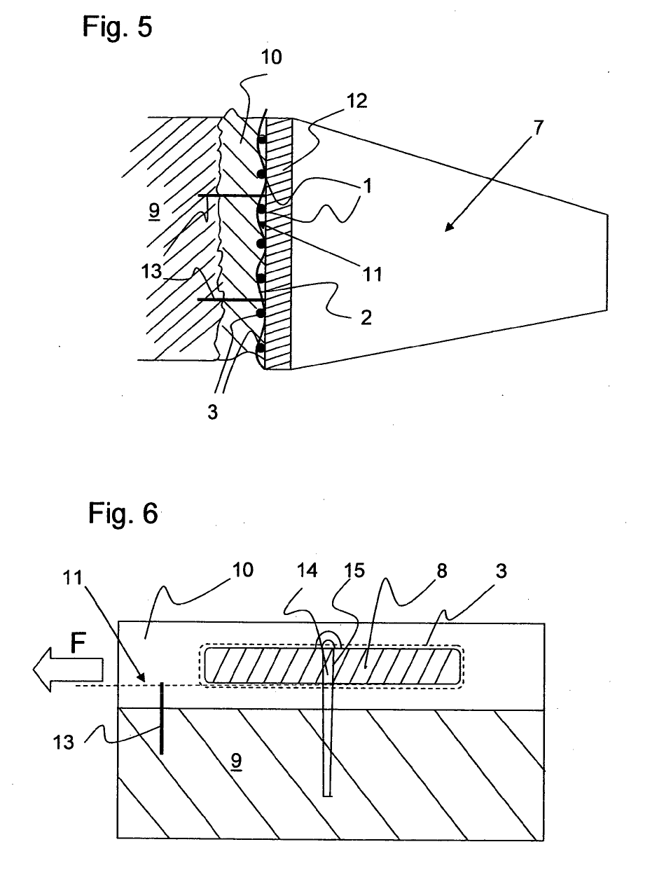

FIG. 5: A reinforced sprayed mortar layer on a wall shown perspectively, represented in a sectional view;

FIG. 6: A final anchoring by means of a final danchoring profile;

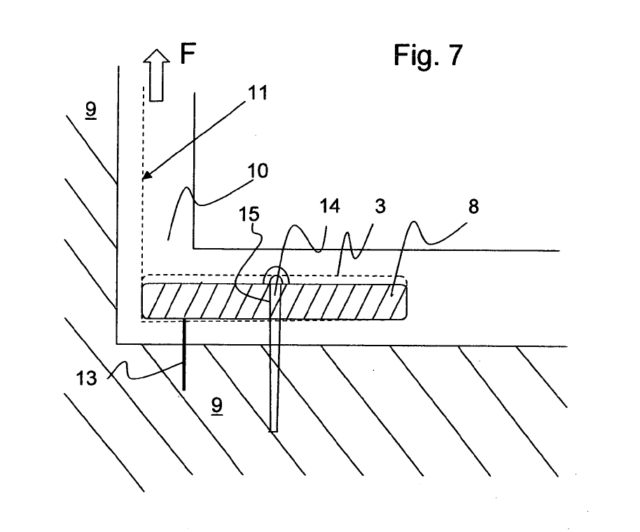

FIG. 7: A final anchoring of the reinforcing mesh by means of a final anchoring's profile in a corner of a building.

FIG. 1 shows in a first alternative how to realise this reinforcing mesh 11. It is a woven fabric. The warp yarns 1 consist of “endless” carbon fibers, whereby the weft threads 2 are introduced in a transversal direction during the manufacturing of the woven fabric in the said warp yars; the said weft threads being realised in the form of cost saving glass or polyester fibers. The woven fabric kann be rolled up to form a reel and then the carbon fibers only extend always in a marked direction, i.e. in the unroll direction while the cost saving fibers which are stabilising the woven fabric extend transversally to the unroll direction of such a woven fabric reel. Thus, expensive carbon fibers, compared to the conventional reinforcing meshes, are employed and extend only in one marked direction, i.e. in the direction in which the woven fabric will be lately effectively subjected to tensile forces. In all other directions, only much cheaper stabilising fibers are employed.

The carbon fibers are high tensile resistant and offer tensile-E-module from 230 to 240 Giga-Pascal. These type of fibers are the so called Rovings. These are fiber bundels or fibers strands of endless, untwisted, and elongated fibers (filaments). If the individual filaments made of glass, Aramid or carbon are combined without being rotated, they are first considered as smooth filament yarns, and when they have a certain thickness (yarn count>68 tex), they are considered as a Roving. Rovings of this type are designated by the number of their filaments or by their weight per length. When indicating the filaments' number, the number is given in full 1000 filaments (1 k). Usual forms of delivery are 1 k (1000 filaments), and also 3 k, 6 k, 12 k and 24 k filaments. The unit for the Tex-number is g/km. It depends on the density of the material which has been used. A Roving-carbon fiber of 12 k has a weight in length of approximately 800 tex. Usual Roving of 800 tex weight therefore 800 g/km or 0.8 g/Meter. Two Rovings of 800 Tex generate a roving of 1600 Tex with then weight of 1.6 g/Meter etc. For usual sprayed mortar meshes, approximately 200 g of carbon fibers per m² are introduced. This generates, when introducing a double thread made of 2×1600-Roving 2×1.6 g per Meter=3.2 g per meter. Therefore, the result is: (200 g./m²)/(3.2 g./m)=62.5 parts/m,→distance/meter between two rovings=1.6 cm mesh size because 1.6 cm×62.5=100 cm.

The weft laid woven fibers of glass or polyester can pass alternatively over and under the warp carbon fibers 1 spaced from one another at about 1.6 cm, or pass respectively over two or more warp threads 1 and then under two or more warp threads again in order to minimize its bending. The following weft thread 2, i.e. the following fibers extending parallely can similarly also pass beneath two or several warp threads 1 made of carbon fibers and therefore pass again over the same number of warp threads 1. The changement from passing over to passing under of the warp threads 1 can be offset from weft to weft in order to increase the stability of the woven fabric. The woven fabric is then coated as described in the following. The main advantage of a reinforcing mesh 11 of this type is that the traction reinforced carbon fibers extending exclusively in the direction here necessary, i.e. in the direction of the warp threads 1 of the woven fabric and extend in other directions which are not subjected to tensile forces on the building, are completely saved. Therefore, with the same carbon fiber cost you can use twice carbon fibers compared to a reinforcing mesh 11 in the traction reinforcing direction; the said reinforcing mesh 11 being traditionally made of carbons fibers and therefore half of the carbon fibers can be saved and be replaced by cheap glass or polyester fibers which are fully sufficient to support the stress in the transversal direction relatively to the traction reinforcement direction. Their function is only to maintain the carbon fibers in their position until the mortar has been installed and set.

FIG. 2 shows a reinforcing mesh 11 in form of a scrim including carbon fibers 3 extending only in a marked direction. The glass or polyester threads of fibers 4 extending transversally to the carbon fibers 3 are laid on some parallely laid carbons fibers 3—therefore the term “scrim”—and laminated. The glass or polyester fibers 4 serve only to maintain the carbon fibers 3 on place inside the scrim for the further traction reinforcement. The same effect is obtained for the traction reinforcement as for a woven fabric. Such a scrim where the cross-over points 5 of carbon fibers 3 and plastic fibers 4 are sticked can later be coated as this will be described in the following.

FIG. 3 finally shows a reinforcing mesh 11 in form of a knitted fabric 6 which serves as a support for the traction reinforcing carbon fibers 3 which then only extend in a marked direction. Such a knitted fabric 6 can be obtained in form of a mesh and present irregular large gaps or passage ways from few up to some millimeters. The individual carbon fiber-section 3 can be applied and laminated extending parallely to each other on a knitted fabric 6 of this type or can be introduced extending parallely to each other through the flat knitted fabric 6 so that the carbon fiber-sections 3 are maintained in the said knitted fabric in their position by the frictional force. The knitted fabric 6 serves only to maintain the traction reinforcing carbon fiber-sections, until this reinforcing mesh 11 is installed in the setting mortar.

As shown in FIG. 4, a reinforcing mesh 11 thus prepared can be rolled around the axis of the extension of the warp threads 2 included in the said reinforcing mesh 11 and extending parallely to each other, i; e. the plastic-fibers. Therefore, the carbon fibers 3, respectively the warp threads 1 extending transversally to the said weft threads can be rolled almost endless and thus, reinforcing mesh 11 can be manufactured almost as long as desired with the traction reinforcing carbon fibers 3 extending in the longitudinal direction of the said reinforcing mesh 11. These reels 8 can be advantageously stored and conveyed in a compact manner.

FIG. 5 shows a sprayed mortar layer on a wall 7 perspectively represented, the construction of which is shown on the front of the picture in a sectional view, and whereby this sprayed mortar layer is armed with a reinforcing mesh 11 according to the invention. For the installation of the reinforcing mesh 11 the underlayment 9 to be equipped and mostly composed of cement, is at first roughened by sand-blasting, water jet machining or by milling. A leveling layer 10 of cementitious mortar is then applied on this roughened surface. A plastic-reinforced cementitious mortar can be used according to the needs. This leveling layer 10 presenting a thickness between 0.5 cm to 1 cm can be applied by means of a wet- or dry-spray method, or the mortar can be applied manually or automatically. In the wet-spray method, the wet mortar is pumped by means of a pump in a hose to a nozzle, wherein under addition of compressed air the mortar is accelerated and sprayed. On the contrary, in the dry spray method, the mortar is pumped dry and in a form of a powder to the nozzle, wherein pressurised water is then added and the mortar is sprayed with a high velocity on the surface to be coated; the said mortar being conveyed by the water-jet, whereby this method is particularly used in the construction of tunnels. In any ways so long as the applied leveling layer 10 is still wet, i.e. is not set and thus soft, the reinforcing mesh 11 here made of horizontally extending carbon fibers 3 is pushed into this leveling layer and thus securely maintained in the said leveling layer. The coating layer 12 is created in that a similar cementitious mortar is again sprayed manually or automatically on the reinforced leveling layer 10 which is still wet and not yet set. The overall thickness of a sprayed mortar layer produced in such a way constituted of a leveling layer 10 and a coating layer 12 is of about 0.5 cm-3.0 cm. Optionally the reinforcing mesh 11 can be additionally fixed mechanically by means of fixing pins 13 on the underlayment 9, when the said reinforcing mesh 11 is installed in the leveling layer 10. Advantageously, the fixing pins 13 are pneumatically fixed with a compressed air installation.

The employed carbon fibers 3 can be realised in a form of open carbon fibers bundels to avoid that the gaps between the fibers and the capillaries are also not filled or closed with a binding agent or an adhesive. The consequence of this is that the flowable or pasty coating material, i.e. normally concrete or mortar reinforced by plastic fibers enter into the gaps between the fibers and form a micro-interlocking together with the fiber structure after the setting, i.e. produce a high positive fit. Moreover, if the choice of the material which is used between the coating material and the fibers' surface is approximately appropriate, the result is an important adhesion between the materials by coating or impregnation of the fibers, particularly by means of a water solvable adhesion promoting agent based on a polymer base. The composition of the adhesion promoting agent is advantageously selected in order to create simultaneously an amplification of the capillary effect and thus support the penetration of the coating material into the gaps between the fibers.

It is essential to have sufficiently large gaps or passage surfaces in the reinforcement in order to form a direct material connection between the leveling layer and the coating layer. The concrete-concrete connection in the mesh area and the concrete-fiberbundel-connection ensure with security the transfer of high shearing stresses resulting from torsion and thermal expansion and therefore avoid the formation of cracks on the surface also under difficult conditions. The overall coating can also have important static functions because of the reinforced, respectively, the reinforcing mesh with a breaking strength of at least 20 kN/m and an elongation at rupture of at most 5%.

The fiber material of the reinforcing mesh can be protected against the attack of aggressive, particularly alkaline components of the leveling layer or coating layer, particularly against the Ca₃Al₂ comprised in the concrete. A reinforcing mesh of this type regardless whether it is a woven fabric, a scrim or a knitted fabric can be therefore equipped with a special coating. Styrene-Butadien-rubber SBR is therefore particularly appropriate, whereby this abbreviation comes from the English term “Styrene Butadiene Rubber”. It is a Copolymer consisting of 1,3-Butadien and Styren. SBR comprises traditionally 23.5% Styren and 76.5% Butadien. Higher Styrene contents create thermoplastic rubber but the rubber remains nonetheless curable. If the reinforcing mesh is impregnated in a SBR-bath, then all the fibers are intimately surrounded by this synthetic rubber of latex type and are no more subjected to any chemicals which exist in the concrete. The embedded reinforcing meshes are therefore made to last indefinitely. A very important advantage by the coating of the said reinforcing mesh is that an amorphous silicate (flue ash) can be sprinkled on the said reinforcing mesh when taken out of the bath or flue ash of this type can be immediately mixed in the bath so that the excessive chalk Ca of the lime mortar bonds with the SiO₂ of the flue ash to form a calciumsilicate hydrate and thus create a higher adhesion in the mortar because of the effective interlocking.

In a practical application, a reinforcing mesh 11 of this type in form of a netting or a woven fabric or a scrim is unrolled in the practical application on the leveling layer 10 which must be prepared, i.e. and this is very important, the carbon fibers 3 must extend in the direction in which the sprayed mortar layer is subjected to tensile forces. The employed sprayed mortar can be appropriate for the hard concrete support or the stuff mortar can be employed, on the other hand, for supple substrate like brickwork composed of bricks, lime sand bricks, respectively, historical fabric of a building. Reinforcing meshes according to the invention have a high tensile resistance and are easy to cut, to install and to fix in a work saving manner. They can be adapted to the form of the support and can be folded even at the edges and corners. After the application of the reinforcing mesh 11, a coating layer 12 is applied which is also composed of sprayed mortar or stuff and can be applied like the leveling layer. The coating layer 12 forms in the example, the exterior ending of the coating. If necessary, another layer can be equipped without problem with the reinforcing meshes, or even a multiple of the said reinforcing meshes can be provided, whereby each reinforcing mesh has a determined protective function. The coating layer in practise often presents a thickness comprised between 5 and 30 mm.

Traditional sprayed mortar present a tensile resistance of more than 1 N/mm². If a reinforcing mesh with a width of 1000 mm can be sprayed on a band width of 100 mm with sprayed mortar, the result is an embedding surface of 1000 mm×100 mm and correspondingly this embedding surface receives tensile forces of more than 1000×100=10⁵ N. The reinforcing meshes presented here can be anchored at the terminal in different ways. In some applications, the reinforcing meshes are rolled around an object, for example around a column or they are installed around the corners. On flat surfaces a sufficient overlapping is realised with a solid support for the anchoring, so that the reinforcing mesh is embedded over a sufficient surface in the sprayed mortar. A traditional reinforcing mesh, which present carbon fibers in the transversal direction must be overlapped over at least 65 cm with the solid support (without security values), i.e. with security values of about 100 cm in order to be able to transfer the forces into the mortar. Because of the manufacturing of grid webs with a width situated between 1.5-4 m, this overlapping is very important and represents high material losses. These important overlappings are often necessary and show that the carbon fibers which are embedded transversely to the tensile direction do not realise their function and are nevertheless expensive. The represented reinforcing mesh with carbon fibers extending in one direction, that is exclusively in the following tensile force direction offers important savings. Several layers of reinforcing meshes are often installed which overlap each time the solid support on the terminal side and thus even multiplying the savings.

In order to reinforce the anchoring on the terminal side, for example, when there is no place for embedding on a large surface on the terminal side, special anchoring elements can be installed. A terminal anchoring of this type is represented in FIG. 6 in a sectional view. This anchoring is constituted of a profile 8 which is embedded in the sprayed mortar layer 10 after this profile 8 has been wrapped by the reinforcing mesh 11 once or several times. A profile 8 made of a corrosion resistant material is the most appropriate, for example, made of a composite-material or of aluminium and having a thickness of about 8 mm and a width of 40 mm, which material can then be cut into handy parts of arbitrary lengths and installed. The edges of this profile 8 should have a radius not smaller than 2 mm to avoid a high bending of the carbon fibers 3. In practise, a layer of sprayed mortar 10 is first applied on the underlayment 9, i.e. the support and the reinforcing mesh 11 is applied on the still supple wet sprayed mortar 10 and fixed where needed by means of pins 13. The profile 8 is then wrapped into the terminal section of the reinforcing mesh 11 and the mesh is then tensed; The profile 8 presents holes 15 through which a concrete plug 14 is then inserted in the underlayment 9 in order to tightly anchor the profile 8 with the support; the reinforcing mesh 11 being tensed. In addition to its mechanical anchoring in the underlayment 9, the wrapped profile 8 is then completely oversprayed with a sprayed mortar 10 in order to be tightly embedded in the said sprayed mortar.

Load tests are realised with standard-sprayed mortar plates having a size of 60 cm×60 cm and a thickness of 10 cm in order to compare the standard plates with steel reinforcement plates. The sprayed mortar plates are manufactured in wood frames. A reinforcing web made of steel wires with a diameter of 6 mm and a mesh size of 150 mm is installed after having filled the wood frames with a 5 cm sprayed mortar layer and with another 5 cm sprayed mortar layer is then oversprayed on the first layer. A reinforcing mesh with a fiber weight of 200 g/m and a tensile resistance (rupture) of 4300 N/mm2 has been installed in a second sprayed mortar plate of such a type after having filled the wood frames with a 2 cm sprayed mortar layer, and a 6 cm sprayed mortar layer is then oversprayed on the first layer. A reinforcing mesh with a fiber weight of 200 g/m and a tensile resistance (rupture) of 4300 N/mm2 has been installed in a third sprayed mortar plate of such a type after having filled the wood frames with a 2 cm sprayed mortar layer, and a 2 cm thick sprayed mortar layer is again oversprayed on the first layer and then a reinforcing mesh of such a type is installed once more and covered with a further layer of 4 cm to obtain a 8 cm sprayed mortar plate. These three test items were dried during 28 days. Then, the energy was measured, i.e. the integral over the flexion when the charge increases until rupture (force×path). The result is a steel reinforcement of 800 Joule and the alternative with an individual reinforcing mesh is 626 Joule, and the alternative with two reinforcing meshes is 1064 Joule. Moreover, the anchoring of the reinforcing webs in these sprayed mortar plates is not strong enough because the anchoring surface is too small. In a tunnel vault, the anchoring surface is, for example, a multiple of the above mentioned surface. Under these conditions, the working volume for one individual reinforcing mesh is of 1000 to 1200 joule, in any ways much more as for a steel reinforcement with a grid composed of steels having a diameter of 6 mm and a mesh size of 150 mm! It is to consider that a reinforcing mesh of this type is much more lighter and is much easier to install compared to a steel-reinforcement web. Further, the durability of the reinforcing mesh in the sprayed mortar is in practise unlimited, especially when the reinforcing mesh has a SBR-coating compared to a steel-reinforcement where the corrosion is always an issue.

It is a principle in the construction engineering that edifices should be suppler on the exterior side with regard to the interior. Accordingly, a hard sprayed mortar should not be applied on a supple substrate (brickwork). The sprayed mortar has to introduce the forces of the carbon fibers into the substrate. The introduction of the forces into the substrate is only possible when the tensile strength of the substrate is strong enough. The tensile strength of the substrate is a measure to determine the amount of tensile forces which can be introduce because the tensile forces of the sprayed mortar and the connection joints are usually much higher than the tensile forces of the substrate. Accordingly, the sprayed mortar must be adjusted on the quality of the substrate. The tensile strength of concrete which is determined by a device for measuring the adhesive tensile strength, is usually between 1.2-5.0 N/mm². And the tension modulus of elasticity of concrete is usually between 20-35 GPa. A sprayed mortar of cementitious basis which is at the most modified with plastic fibers or/and other additives is used accordingly on this hard support. In the harden state, the sprayed mortar presents the following quality features: tensile strength 3-10 N/mm², 20-tension modulus of elasticity 30 GPa.

The tensile strength of the brickwork—determined by a device for measuring the adhesive tensile strength—is usually—on the other hand->0.3-1.0 N/mm². A sprayed layer of cementitious or lime base with the corresponding additives is used on this supple substrate. In the harden state, the sprayed mortar presents the following quality features: tensile strength 1-5 N/mm², tension modulus of elasticity 8-20 GPa. In particular, historical brickwork must be treated with much attention. Such historical brickwork has mostly a tensile strength slightly over 0.3 N/mm2. On such soft supports, a sprayed layer of hydraulic chalk basis with the corresponding additives is used. In the harden state, the sprayed mortar presents the following quality features: tensile strength 0.5-3 N/mm², tension modulus of elasticity 2-15 GPa.

It is of crucial importance that the carbon fibers-reinforcements which are applied on the exterior side or the internal side of an existing brickwork by means of a sprayed mortar are anchored in the adjacent element. Especially when postreinforcement treatments against earthquakes are realised, tensile forces appear also in the vertical direction. An effect of an earthquake is that the edifice is lifted and therefore the edifice can prematurely collapse in case of additional horizontal load. A brickwork which is situated between two concrete plates (base plate as well as ceiling) respectively between the base plate or the base and a wooden ceiling is anchored with the anchoring element in the connected elements. FIG. 7 shows how an anchoring of this type has been realised by means of a corner of a building, seen from above in a plan view. The anchoring element in form of a profile 8 composed of aluminium or other composite material is wrapped in corner area of the reinforcing mesh 11 and then anchored with the solid underlayment 9 of concrete, wood or steel by means of strong plugs 14 or screws. These forces are introduced only by means of these plugs via the additional contact pressure. An anchoring element of this type, preferably a perforated aluminium profile can thus be applied over the entire width of the carbon fibers grid by means of anchoring screws 14 into concrete, wood or steel. The reinforcing mesh 11 is integrated into the wet sprayed mortar 10. The anchoring element, i.e. the profile 8 is applied when wet and the sprayed mortar 10 is therefore anchored under pressure against the reinforcing mesh 11. The reinforcement element is then covered wet in a wet identical sprayed mortar 10. It is understood that reinforcing meshes 11 of this type can also be installed cross-wise one above the other and can be covered with sprayed mortar 10 in order to introduce tensile forces of any direction into the building or into the underlayment 9.

### REFERENCES

1 Warp threads
2 Weft threads
3 Carbon fibers
4 Fibers of glass—or Polyester
5 Cross-over point of the scrim
6 Knitted fabric
7 Wall
8 Profile, aluminium profile
9 Underlayment
10 Leveling layer
11 Reinforcing mesh
12 Cover layer
13 Haltenagel
14 Plug
15 Hole in the profile 8

1. A reinforcing mesh for a reinforced mortar or sprayed mortar layer on an underlayment, wherein the reinforcing mesh comprises carbon fibers extending only in a marked direction, wherein the carbon fibers form together with fibers made of glass or polyester extending in one or more other directions, a woven fabric, a scrim or a knitted fabric having a mesh size of at least 10 mm, whereby the employed carbon fibers have a tensile E-modul of elasticity greater than 200 gigapascals or 2000 kbar.

2. A reinforcing mesh for a reinforced mortar or sprayed mortar layer on an underlayment according to claim 1, wherein the reinforcing mesh is realised in a form of woven fabrics with the carbon fibers extending only in a marked direction as warp yarns, whereby the weft threads are made of glass or polyester fibers.

3. A reinforcing mesh for a reinforced mortar or sprayed mortar layer on an underlayment according to claim 1, wherein the reinforcing mesh is realised as scrims with the carbon fibers extending only in a marked direction and the said reinforcing mesh is laid on glass or polyester fibers extending in other directions and is connected to the said glass or polyester fibers by lamination.

4. A reinforcing mesh for a reinforced mortar or sprayed mortar layer on an underlayment according to claim 1, wherein the reinforcing mesh is realised in a form of a knitted fabric together with the carbon fibers extending only in a marked direction and the said reinforcing mesh is laminated on a knitted fabric of glass or polyester fibers or inserted in the said knitted fabric.

5. A reinforcing mesh according to claim 1, wherein the scrim or the woven fabric has a mesh size comprised between 0.5 cm and 5.0 cm with quadratic or rectangular mesh-gaps.

6. A reinforcing mesh according to claim 1, wherein the fibers of the scrim, the woven fabric or of the knitted fabric present a water solvable adhesion promoting coating based on a polymer.

7. A reinforcing mesh according to claim 1, wherein the fibers of the scrim, the woven fabric or of the knitted fabric are equipped with a coating of latex type made of styrene-butadien-rubber SBR; the said coating being blended with an amorphous silicate (flue ash).

8. A reinforcing mesh according to claim 1, wherein this reinforcing mesh presents a tensile force of at least 20 kN/m and of at most 800 kN/m in the marked direction of the comprised carbon fibers and an elongation at rupture of at most 2%.

9. A method for the installation of a reinforcement mesh according to claim 1 in order to produce a reinforced mortar layer or a reinforced sprayed mortar layer on an underlayment mostly composed of concrete with the method comprising the following steps:
a) roughening the surface of the underlayment,
b) applying a leveling layer of cementitious mortar to the rough surface of the underlayment,
c) fastening the reinforcing mesh by pressing the reinforcing mesh into the wet, not yet set leveling layer,
d) applying a cover layer of the identical cementitious mortar to the wet, not yet set, reinforced leveling layer.

10. The method according to the claim 9 the method comprising the following steps:
a) roughening the surface of the underlayment by sand-blasting, water-jet machining or by milling,
b) manual application or machine spraying of a leveling layer of cementitious mortar on the rough surface of the underlayment by a wet or dry spraying method,
c) fastening the reinforcing mesh by pressing the reinforcing mesh into the wet, not yet set leveling layer,
d) manual application or machine spraying of a cover layer of identical cementitious mortar by a wet or dry spraying method in the wet, not yet set, reinforced leveling layer.

11. The method according to claim 9, wherein as much cementitious concrete is applied so that the total thickness of the sprayed mortal layer is situated between 0.5 cm-3.0 cm.

12. The method according to claim 9, wherein a cementitious mortar reinforced by plastics is applied as a leveling layer and as a cover layer wherein a total thickness of the leveling layer and the cover layer is between 0.5 cm-3 cm.

13. The method according to claim 9, wherein, according to c) the reinforcing mesh is fixed additionally and mechanically on the underlayment by means of fixing pins.

14. The method according to claim 9, wherein, according to c) the reinforcing mesh is rolled on the endside around an anchoring profile in the form of a corrosion resistant profile corrosion resistant profile having edges with a radius of at least 2 mm; the said profile being fixed by means of plugs with the sprayed mortar layer which has been already applied and fixed with the underlayment and is then oversprayed with the identical sprayed mortar.

15. A reinforced mortar coating produced according to the method of claim 14, wherein the reinforcing mesh of the mortar layer is secured at least on one side of its tensile load by means of one corrosion resistent profile, which is anchored in the underlayment by means of plugs; the said profile being wrapped at least one time by the reinforcing mesh.
